(19) United States
(12) Patent Application Publication
(10) Pub. No.: US 2005/0245384 A1
(43) Pub. Date: Nov. 3, 2005

(54) Glass composition for lamps and lamp manufactured from the same

(76) Inventor: Masanobu Ito, Kyoto-shi (JP)

Correspondence Address: SNELL & WILMER L.L.P., 600 ANTON BOULEVARD, SUITE 1400, COSTA MESA, CA, 92626, US

(21) Appl. No.: 11/111,381

(22) Filed: Apr. 21, 2005

(30) Foreign Application Priority Data
Apr. 28, 2004 (JP) JP2004-134518

(51) Int. Cl. C03C 3/087; C03C 3/095

(52) U.S. Cl. 501/70; 501/64

(57) ABSTRACT

A glass composition for glass components of lamps includes: SiO₂ 55-80 wt %; Al₂O₃ 0.5-5 wt %; B₂O₃ 0-5 wt %; Na₂O 2-15 wt %; Li₂O 0-5 wt %; K₂0 1-15 wt %; MgO 0.1-10 wt %; CaO 0.1-10 wt %; SrO 0-4 wt %; BaO 0-4 wt %; ZnO 0-5 wt %; Sb₂O₃ 0-1 wt %; and CeO₂ 0-1 wt %. The total content of Na₂O, Li₂O, and K₂O falls within a range of 3-25 wt %. The total content of MgO, CaO, SrO, BaO, and ZnO falls within a range of 1-20 wt %. The total content of SrO and BaO is less than 4 wt %. The ratio of Li₂O to Na₂O by weight falls within a range of 0.05:1 to 0.7:1. The ratio of K₂O to Na₂O by weight falls within a range of 0.4:1 to 1.3:1.

This application is based on an application No. 2004-134518 filed in Japan, the contents of which are hereby incorporated by reference.

### BACKGROUND OF THE INVENTION

(1) Field of the Invention

The present invention relates to a glass composition for lamps and also to a lamp manufactured from the glass composition.

(2) Description of the Related Art

Generally, glass components of lamps, such as glass bulbs and flare stems, are manufactured from glass having good electrical insulation. By virtue of the good electrical insulation, it is avoided that an electric current flows to such a glass component to cause short-circuit in an illumination apparatus and that abnormal heat is generated to melt the glass component. In addition, when manufacturing glass bulbs with a bend so as to be U-shaped, for example, glass having favorable properties for secondary work (bending a tubular straight glass bulb by heating) is used.

When good electrical insulation and secondary workability are desirable, it is conventionally common to use glass with a high content of lead oxide (PbO), which is generally referred to as lead-glass. Recently, however, lead-glass is subjected to public regulation because it contains a toxic substance of lead. In view of the above, there have been suggested a number of types of glass with a high content of strontium oxide (SrO) and barium oxide (BaO) as glass comparable to lead-glass in electrical insulation and secondary workability. See for example, JP Patent Application Publications No. 9-12332 and No. 2003-306344.

Unfortunately, however, BaO and SrO cannot be obtained from natural ores and thus are expensive. Consequently, with the use of glass containing a large amount of BaO and SrO, the manufacturing cost of lamps inevitably is relatively high. In addition, such glass with a high content of BaO and SrO results in low manufacturing yields in the primary work (tube drawing for manufacturing tubular and straight glass bulbs from glass molten in a furnace).

One factor lowering the primary work yields is the occurrence of striae or thread-like veins within glass bulbs (hereinafter, striae defects) upon altering glass bulb diameter (hereinafter, a product changeover). Since glass with a high content of SrO and BaO tends to be inconsistent in their constituents in the molten state, it is necessary to convectively circulate the molten glass in a furnace to a sufficient degree. Yet, it is assumed that the convection of molten glass is often disturbed upon a product changeover.

### SUMMARY OF THE INVENTION

In view of the above problems, a primary object of the present invention is to provide a glass composition for lamps that is comparable to lead-glass in electrical insulation and secondary workability, and that is low in cost and excellent in primary workability.

The above primary object is achieved by a glass composition for lamps, containing: SiO₂ 55-80 wt %; Al₂O₃ 0.5-5 wt %; B₂O₃ 0-5 wt %; Na₂O 2-15 wt %; Li₂O 0-5 wt %; and K₂O 1-15 wt %. The total content of Na₂O, Li₂O, and K₂O falls within a range of 3-25 wt %. The glass composition further contains: MgO 0.1-10 wt %; CaO 0.1-10 wt %; SrO 0-4 wt %; BaO 0-4 wt %; and ZnO 0-5 wt %. The total content of MgO, CaO, SrO, BaO, and ZnO falls within a range of 1-20 wt %. The glass composition further contains: Sb₂O₃ 0-1 wt %; and CeO₂ 0-1 wt %. The total content of SrO and BaO is less than 4 wt %. The ratio of Li₂O to Na₂O by weight falls within a range of 0.05:1 to 0.7:1. The ratio of K₂O to Na₂O by weight falls within a range of 0.4:1 to 1.3:1.

The glass composition stated above is inexpensive because the content of SrO and BaO is low. In addition, the manufacturing yields in the primary work of glass bulbs improve. Consequently, the manufacturing cost of lamps is reduced. Owing to its secondary workability and electrical insulation comparable to lead-glass, glass manufactured from the above glass composition is a suitable substitute for lead-glass.

Here, a volume resistivity p at a temperature of 250° C. may be 10^{8.5} Ω·cm or higher.

With the glass composition stated above, a high quality lamp is manufactured, which is free from short circuit of an illumination apparatus or from abnormal heat in the glass bulb.

Here, an expansion coefficient at a temperature range of 30° C. to 380° C. may fall within a range of 90×10⁻⁷/K to 98×10⁻⁷/K.

With the glass composition stated above, the resulting expansion coefficient is good approximation of the expansion coefficient of lead wires constituting electrodes, at portions sealed within a flare stem (portions of the lead wires made of Dumet wire). This serves to provide excellent electrode sealing property, so that a highly reliable lamp can be manufactured.

Another object of the present invention is to provide a lamp requiring a low manufacturing cost.

The object stated above is achieved by lamp composed of a glass bulb manufactured from the glass composition containing: SiO₂ 55-80 wt %; Al₂O₃ 0.5-5 wt %; B₂O₃ 0-5 wt %; Na₂O 2-15 wt %; Li₂O 0-5 wt %; K₂O 1-15 wt %, MgO 0.1-10 wt %; CaO 0.1-10 wt %; SrO 0-4 wt %; BaO 0-4 wt %; and ZnO 0-5 wt %, Sb₂O₃ 0-1 wt %; and CeO₂ 0-1 wt %. The total content of Na₂O, Li₂O, and K₂O falls within a range of 3-25 wt %. The total content of MgO, CaO, SrO, BaO, and ZnO falls within a range of 1-20 wt %. The total content of SrO and BaO is less than 4 wt %. The ratio of Li₂O to Na₂O by weight falls within a range of 0.05:1 to 0.7:1. The ratio of K₂O to Na₂O by weight falls within a range of 0.4:1 to 1.3:1.

The structure stated above allows a glass bulb to be manufactured at a low cost as stated in the foregoing paragraphs, and thus the lamp itself is allowed to be manufactured at a low cost.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a side view showing a lamp according to one embodiment of the present invention;

FIG. 2 is an enlarged sectional view showing an end section of an arc tube of the lamp;

FIG. 3 is a table of test results; and

FIG. 4 is a table of test results.

### DESCRIPTION OF THE PREFERRED EMBODIMENT

I. Lamp Structure

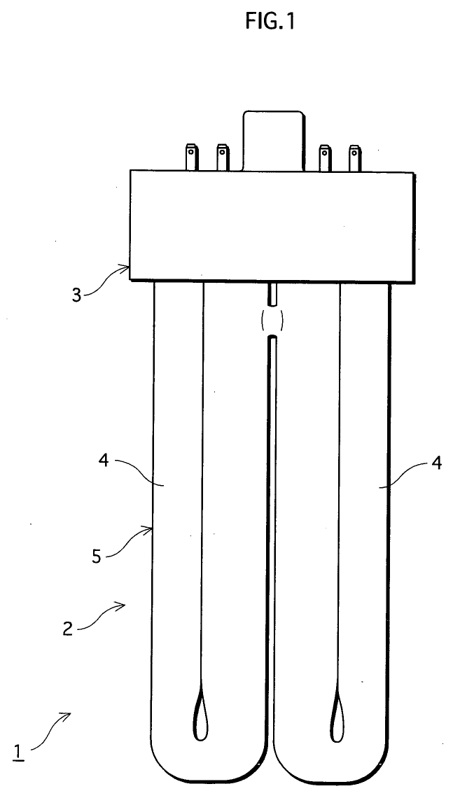

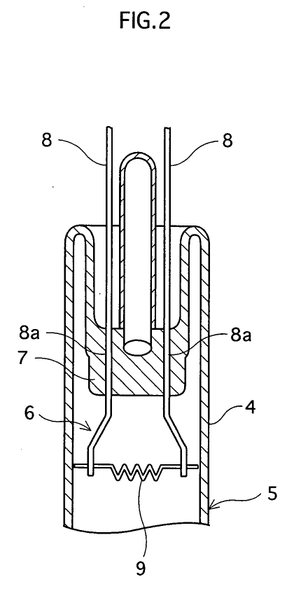

The following describes a fluorescent lamp according to an embodiment of the present invention, with reference to FIGS. 1 and 2. FIG. 1 is a side view showing the lamp, whereas FIG. 2 is an enlarged sectional view showing an end section of an arc tube of the lamp.

As shown in FIG. 1, the lamp according to the present embodiment is a compact fluorescent lamp 1 composed of an arc tube 2 and a base 3. The arc tube 2 is in turn composed of an arc tube body 5 formed with a plurality of, bridge-connected U-shaped glass bulbs 4. As shown in FIG. 2, a flare stem 7 is sealed at each end of the arc tube body 5. Each flare stem 7 is provided with an electrode 6.

Each electrode 6 is composed of a pair of lead wires 8 provided through the flare stem 7, and a filament coil 9 extending across ends of the respective lead wires 8. A portion 8a of each lead wire 8 sealed within the flare stem 7 is made of Dumet wire (expansion coefficient: 94×10⁻⁷/K). In addition, the arc tube body 5 has an inner surface coated with a layer of tri-band phosphor (color temperature: 5000K), and is filled with mercury and an inert gas.

II. Constituents of Glass Composition

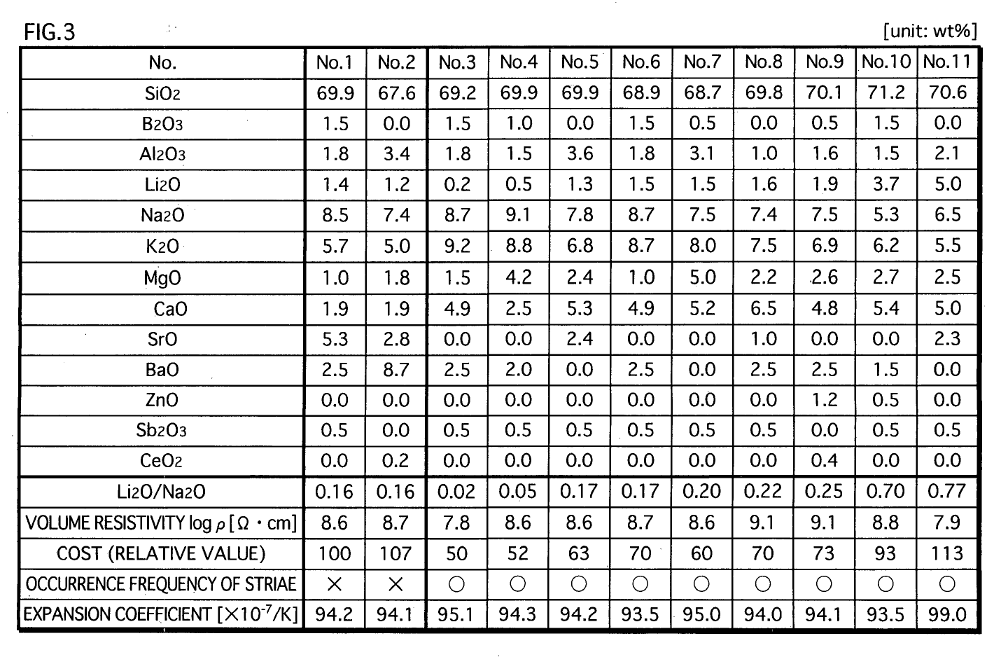

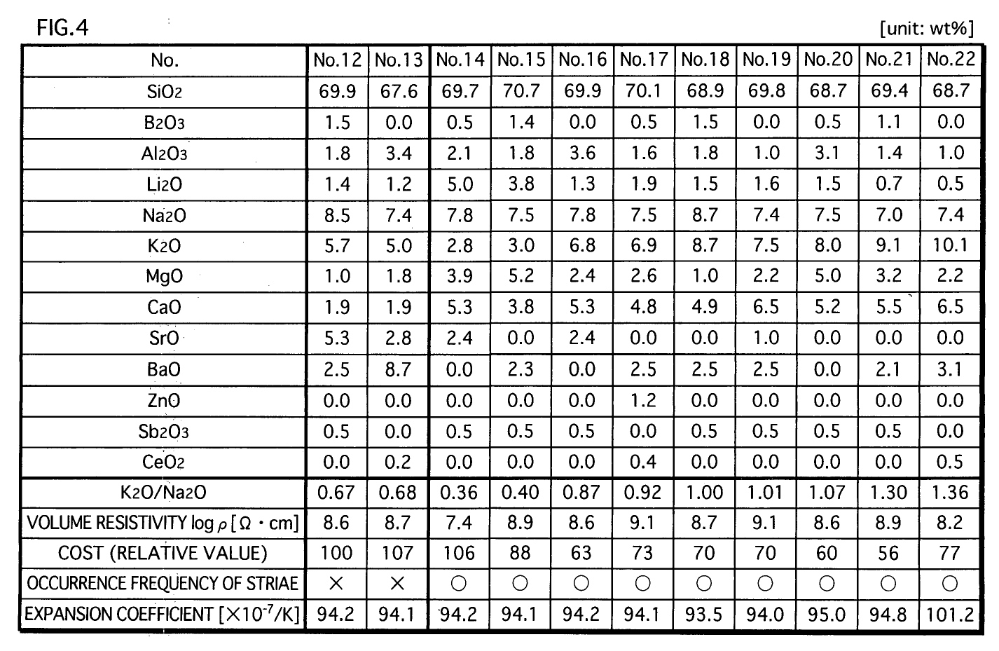

The glass bulb 4 described above is manufactured from any of the glass compositions Nos. 4-10 shown in FIG. 3 and Nos. 15-21 shown in FIG. 4.

It should be appreciated that the constituents of the glass compositions are not limited to the specific examples shown in the figures. Yet, it is essential that the following constituents are contained in the following ranges, for ensuring suitable properties as a glass bulb of a lamp.

That is, each glass composition needs to contain: SiO₂ 55-80 wt %; Al₂O₃ 0.5-5 wt %; B₂O₃ 0-5 wt %; Na₂O 2-15 wt %; Li₂O 0-5 wt %; and K₂O 1-15 wt %, where the total content of Na₂O, Li₂O and K₂O is 3-25 wt %. The glass composition needs to further contain: MgO 0.1-10 wt %; CaO 0.1-10 wt %; SrO 0-4 wt %; BaO 0-4 wt %; and ZnO 0-5 wt %, where the total content of MgO, CaO, SrO, BaO, and ZnO is 1-20 wt %. The glass composition needs to further contain: Sb₂O₃ 0-1 wt %; and CeO₂ 0-1 wt %.

SiO₂ is a constituent acting as a main network former in the glass structure. The content of SiO₂ is 55-80 wt %. If the SiO₂ content is below 55 wt %, the chemical resistance of the glass is reduced. In addition, the expansion coefficient of the glass becomes too high, which results in poor sealing of the electrodes. On the other hand, if the SiO₂ content is above 80 wt %, the viscosity of the. glass becomes too high, so that the meltability is impaired. In addition, the expansion coefficient of the glass becomes too low, which results in poor sealing of the electrodes.

Al₂O₃ is a constituent for improving the chemical resistance of the glass. The content of Al₂O₃ is 0.5-5 wt %. If the Al₂O₃ content is below 0.5 wt %, the chemical resistance of the glass is reduced. On the other hand, if the Al₂O₃ content is above 5 wt %, the viscosity of the glass becomes too high, so that the meltability is impaired. As a result, striae appear in the resulting glass bulb.

B₂O₃ is a constituent for improving the meltability of the glass and adjusting the viscosity. The content of B₂O₃ is 0-5 wt %. If the B₂O₃ content is above 5 wt %, the chemical resistance of the glass is reduced. In addition, the expansion coefficient becomes too low, which results in poor sealing of the electrodes.

Na₂O is an essential constituent for improving the meltability of the glass. The content of Na₂O is 2-15 wt %. If the Na₂O content is below 2 wt %, the viscosity of the glass becomes too high and thus the meltability is impaired. On the other hand, if the Na₂O content is above 15 wt %, the chemical resistance of the glass is reduced.

Li₂O is a constituent for improving, in a mixture with Na₂O, the chemical resistance and the electrical insulation of the glass (hereinafter, this effect is referred to as “mixed alkali effect”). The content of Li₂O is 0-5 wt %. If the Li₂O content is above 5 wt %, the manufacturing cost becomes high. In addition, the expansion coefficient of the glass becomes too high, which results in poor sealing of the electrodes.

K₂O is an essential constituent for achieving the mixed alkali effect. The content of K₂O is 1-15 wt %. If the K₂O content is below 1 wt %, the mixed alkali effect cannot be achieved. On the other hand, if the K₂O content is above 15 wt %, the expansion coefficient of the glass becomes too high, which results in poor sealing of the electrodes.

Na₂O, Li₂O, and K₂O are alkali metals. As mentioned above, a mixture of two or three of the alkali metals achieves the mixed alkali effect. The content of the mixture is 3-25 wt %. If the total content of Na₂O, Li₂O, and K₂O is below 3 wt %, the viscosity of the glass becomes too high, so that the meltability is impaired. On the other hand, if the total content of Na₂O, Li₂O, and K₂O is above 25 wt %, the expansion coefficient of the glass becomes too high, which results in poor sealing of the electrodes. In addition, the chemical resistance of the glass is reduced.

If the ratio of Li₂O to Na₂O by their respective weights is smaller than 0.05:1, the electrical insulation is impaired. On the other hand, if the ratio of Li₂O to Na₂O is larger than 0.7:1, the electrical insulation is also impaired.

If the ratio of K₂O to Na₂O by their respective weights is smaller than 0.4:1, the electrical insulation is impaired. On the other hand, if the ratio of K₂O to Na₂O is larger than 1.3:1, the electrical insulation is also impaired.

MgO is an essential constituent for improving the secondary workability and the electrical insulation of the glass. The content of MgO is 0.1-10 wt %. If the MgO content is below 0.1 wt %, the meltability of the glass is impaired. On the other hand, if the MgO content is above 10 wt %, there is a risk of crystallization of the glass.

CaO is an essential constituent for improving the secondary workability and the electrical insulation of the glass. The content of CaO is 0.1-10 wt %. If the CaO content is below 0.1 wt %, the meltability of the glass is impaired. On the other hand, if the CaO content is above 10 wt %, there is a risk of crystallization of the glass.

ZnO is a constituent for improving the secondary workability and the electrical insulation of the glass. The content of ZnO is 0-5 wt %. If the ZnO content is above 5 wt %, there is a risk of crystallization of the glass.

If the total content of MgO, CaO, SrO, BaO, and ZnO is below 1 wt %, there is no improvement of the secondary workability and the electrical insulation of the glass. On the other hand, if the total content of MgO, CaO, SrO, BaO, and ZnO is above 20 wt %, there is a risk of crystallization of the glass.

Sb₂O₃ is a constituent for fining the glass melt, so that generation of striae and bubbles are prevented and thus the manufacturing yields in the primary work improves. The content of Sb₂O₃ is 0-1 wt %. If the Sb₂O₃ content is above 1 wt %, the glass is colored and no longer suitable for a lamp.

CeO₂ is a constituent for fining the glass melt and also for blocking ultraviolet rays. The content of CeO₂ is 0-1 wt %. If the CeO₂ content is above 1 wt %, the glass is colored and no longer suitable for a lamp.

Note that by the presence of both CeO₂ and Sb₂O₃ together, the coloring of glass becomes more notable. Thus, it is preferable that only one of CeO₂ and Sb₂O₃ is contained. SrO and BaO are constituents having the effect of improving the electrical insulation of the glass. The effect is achieved owing to the fact that the atomic radii of Strontium (Sr) and Barium (Ba) is relatively large. As mentioned above, however, SrO and BaO are expensive raw materials. Thus, the more SrO and BaO are contained, the higher the cost of glass will be. Also as mentioned above, if the content of SrO and BaO is too high, the primary workability of the glass is impaired. Accordingly, it is preferable that the total content of SrO and BaO is maintained within the lowest possible range for ensuring the electrical insulation of the glass. When the total content of SrO and BaO is below 4 wt %, the significant effects of reduced cost and improved primary workability are achieved.

Especially, the above effects of reduced cost and improved primary workability are even more significant when the total content of SrO and BaO is 0 wt %. In addition, the glass composition containing no SrO and BaO achieves an effect on the aspect of manufacturing facilities because the required number of raw material silos for glass manufacturing can be reduced by two. Further, when the content of either SrO or BaO is 0 wt %, the effect of cost reduction and improved primary workability are achieved. In addition, the required number of raw material silos can be reduced by one.

Conventionally, if the total content of SrO and BaO is below 4 wt %, the resulting glass fails to ensure the electrical insulation required for lamp components. However, by limiting the weight ratio of Li₂O and Na₂O to 0.05-0.7:1, and the weight ratio of K₂O and Na₂O to 0.4-1.3:1, the present invention manages to ensure the electrical insulation required for a glass bulb, even if the total content of SrO and BaO is below 4 wt %.

Note it is confirmed that a small amount of iron oxide (Fe₂O₃), titanium oxide (TiO₂), zirconium oxide (ZrO), and tin oxide (SnO₂) may be added as required.

III. Test Results

Test 1: Study on Weight Ratio of Li₂O and Na₂O

As shown in FIG. 3, different types of glass were prepared according to the compositions Nos. 1-11 having different weight ratios of Li₂O and Na₂O, and their properties were measured. Specifically, the electrical insulation, the raw material cost, the primary workability, and the expansion coefficient of each type of glass were measured in order to evaluate the influence of the different weight ratios of Li₂O and Na₂O on the glass properties. Note that the primary work refers to manufacturing of a straight and tubular glass bulb from the molten glass, and the expansion coefficient represents the degree of thermal expansion of the glass.

The compositions Nos. 1 and 2 are of conventional glass with a high content of SrO and BaO. The glass compositions Nos. 3-11 contain SrO and BaO in an amount not exceeding 4 wt % in total.

The electrical insulation is evaluated by measuring the volume resistivity ρ. Samples for the measurement were prepared by shaping respective types of glass into a disc 25 mm in diameter and about 4 mm in thickness. On one main surface of each sample, an electrode layer having a 10 mm diameter was formed with silver paste. On the other main surface, an electrode layer having a 10 mm or greater diameter was also formed with silver paste. Each sample was placed in a furnace maintained at 250° C. and lead wires were connected to the respective electrode layers. The volume resistivity ρ of each sample was then measured with a digital megohmmeter (DKK-TOA Cooperation, Model No. DSM-8103).

Note it is preferable for the glass bulb 4 of a fluorescent lamp that the volume resistivity p at the temperature of 250° C. measures at least 10^{8.5} Ω·cm. If the volume resistivity ρ measured 10^{8.5} Ω·cm or higher, the glass is evaluated as having good electrical insulation.

The cost of each sample is numerically expressed in relation to the sample No. 1 of which cost taken as 100.

The primary workability is evaluated in the occurrence frequency of striae defects in a glass bulb during manufacturing. Specifically, the glass compositions are evaluated as “o” if striae defects were generated upon a product changeover only to an extent not adversely affecting the productivity of glass bulbs. If there was a risk of adversely affecting the glass bulb productivity, the glass compositions are evaluated as “x”.

The expansion coefficient was measured with a thermomechanical analyzer (Rigaku Cooperation, TAS300 TMA 8140C). For the measurement, samples were prepared by shaping respective glasses into a disc of 5 mm in diameter and about 10 mm in thickness. The average coefficient of linear expansion of each sample was measured with the thermomechanical analyzer for a heating from 30° C.-380° C., in accordance with the compressive load method (JIS R 3102).

As shown in FIG. 3, the sample of glass composition No. 3 containing Li₂O and Na₂O in a ratio of 0.02:1 measured 10^{7.8} Ω·cm in the volume resistivity ρ, thereby exhibiting poor electrical insulation.

The sample of glass composition No. 11 containing Li₂O and Na₂O in a ratio of 0.77:1 measured 10^{7.9} Ω·cm or less in the volume resistivity ρ, thereby exhibiting poor electrical insulation. In addition, the relative cost value of the glass composition No. 11 is 113, which indicates higher cost than the conventional glass compositions Nos. 1 and 2. The glass composition No. 11 is more expensive because of a high content of Li₂O, which is an expensive raw material. In addition, the expansion coefficient of the sample of the glass composition No. 11 measured 99×10⁻⁷/K, which led to poor electrode sealing.

Tuning now to the glass compositions Nos. 4-10 each containing Li₂O and Na₂O in a ratio of 0.05-0.7:1 measured 10^{8.5} Ω·cm or higher in the volume resistivity ρ, thereby exhibiting good electrical insulation. In addition, the relative cost values of the glass compositions Nos. 4-10 are all equal to or less than 100, which indicate lower cost than that of the conventional glass compositions Nos. 1 and 2. Especially, the relative cost value of the glass composition No. 4 is 52, which indicates about half the cost of conventional glass. In addition, the glass compositions Nos. 4-10 are of high primary workability without occurrence of striae, and of good electrode sealing with the expansion coefficient falling within the approximation range (90×10⁻⁷/K to 9×10⁻⁷/K) to the expansion coefficient of the Dumet wire. In addition, although not shown in FIG. 3, the glass compositions Nos. 4-10 exhibited good secondary workability.

In light of the above test results, the weight ratio of Li₂O to Na₂O preferably falls in the range of 0.05-0.7:1.

Test 2: Study on Weight Ratio of K₂O and Na₂O

As shown in FIG. 4, different types of glass were prepared according to the compositions Nos. 12-22 having different weight ratios of K₂O and Na₂O. Specifically, the electrical insulation, the raw material cost, the primary workability, and the expansion coefficient of each type of glass were measured in order to evaluate the influence of the different weight ratios of K₂O and Na₂O on the glass properties.

The compositions Nos. 12 and 13 are of conventional glass containing a high content of SrO and BaO. The glass compositions Nos. 14 and 22 contain SrO and BaO in an amount not exceeding 4 wt % in total.

The electrical insulation, cost, primary workability, expansion coefficient of each glass were measured in the same manner as the test 1.

As shown in FIG. 4, the glass composition No. 14 containing K₂O and Na₂O in a weight ratio 0.36:1 measured 10^{7.4} Ω·cm in the volume resistivity ρ, thereby exhibiting poor electrical insulation. In addition, the relative cost value of the glass composition No. 14 is 106, which indicates a higher cost than that of the conventional glass composition No. 12.

The glass composition No. 22 containing K₂O and Na₂O in a weight ratio 1.36:1 measured 10^{8.2} Ω·cm in the volume resistivity ρ, thereby exhibiting poor electrical insulation. In addition, the expansion coefficient of the glass composition No. 22 measured 101.2×10⁻⁷/K, which led to poor electrode sealing.

On the other hand, the glass compositions Nos. 15-21 containing K₂O and Na₂O in the ratio of 0.4-1.3:1 measured 10^{8.5} Ω·cm or higher in the volume resistivity ρ, thereby exhibiting good electrical insulation. In addition, the relative cost values of the glass compositions Nos. 15-21 are equal to or smaller than 100, which indicate a lower cost than that of the conventional glass compositions Nos. 12 and 13. In addition the glass compositions Nos. 15-21 are of high primary workability free from occurrence of striae, and of good electrode sealing with the expansion coefficient falling within the approximation range (90×10⁻⁷/K to 98×10⁻⁷/K) to the expansion coefficient of the Dumet wire. In addition, although not shown in FIG. 4, the glass compositions Nos. 15-21 exhibited good secondary workability.

In light of the above test results, the weight ratio of K₂O and Na₂O preferably falls in the range of 0.4-1.3:1.

The glass composition according to the present invention is applicable to compact fluorescent lamps, circline fluorescent lamps, tubular fluorescent lamps, and mercury vapor discharge lamps other than fluorescent lamps. The glass composition according to the present invention is especially suitable for lamps of which a glass bulb has a bend.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. A glass composition for glass components of lamps comprising:
SiO₂ 55-80 wt %;
Al₂O₃ 0.5-5 wt %;
B₂O₃ 0-5 wt %;
Na₂O 2-15 wt %;
Li₂O 0-5 wt %; and
K₂O 1-15 wt %,
the total content of Na₂O, Li₂O, and K₂O falling within a range of 3-25 wt %,
the glass composition further comprising:
MgO 0.1-10 wt %;
CaO 0.1-10 wt %;
SrO 0-4 wt %;
BaO 0-4 wt %; and
ZnO 0-5 wt %,
the total content of MgO, CaO, SrO, BaO, and ZnO falling within a range of 1-20 wt %,
the glass composition further comprising:
Sb₂O₃ 0-1 wt %; and
CeO₂ 0-1 wt %, wherein
the total content of SrO and BaO is less than 4 wt %,
the ratio of Li₂O to Na₂O by weight falls within a range of 0.05:1 to 0.7:1, and
the ratio of K₂O to Na₂O by weight falls within a range of 0.4:1 to 1.3:1.

2. The glass composition according to claim 1, wherein
a volume resistivity p at a temperature of 250° C. is 10^{8.5} Ω·cm or higher.

3. The glass composition according to claim 1, wherein
an expansion coefficient at a temperature range of 30° C. to 380° C. falls within a range of 90×10⁻⁷/K to 98×10⁻⁷/K.

4. A lamp composed of a glass bulb manufactured from the glass composition as defined in claim 1.
